(19) United States
(12) Patent Application Publication
(10) Pub. No.: US 2018/0203676 A1
(43) Pub. Date: Jul. 19, 2018

(54) REMOVING LIBRARY OBJECTS FROM A STATIC LIBRARY

(71) Applicant: LONGSAND LIMITED, Cambridge Cambridgeshire (GB)

(72) Inventor: James Howe, Cambridgeshire (GB)

(21) Appl. No.: 15/565,283

(22) PCT Filed: Apr. 9, 2015
(86) PCT No.: PCT/EP2015/057790

§ 371 Date: Oct. 9, 2017

(51) Int. Cl. G06F 8/41; G06F 8/54; G06F 8/36

(52) U.S. Cl. CPC G06F 8/4435; G06F 8/36; G06F 8/54

(57) ABSTRACT

Methods, devices, and techniques for performing dead code stripping are discussed herein. For example, in one aspect, a symbol list may be created based on global symbols declared in a static library header. A symbol-to-object mapping may also be created from the static library. The symbol-to-object mapping may include data that maps the global symbols to library objects of the static library. An iteration of a dead code stripping loop may be executed. The first iteration may involve selecting a first global symbol from the global symbol list. The first iteration may also involve, using the symbol-to-object mapping, determining that the first symbol is defined by a first object. Still further, the first iteration may involve adding the first library object to a verified object list. Library objects are then removed from the static library that are absent from the verified object list.

### BACKGROUND

A static library (also referred to as an archive) may be a linkable executable artifact that provides code (e.g., machine readable instructions) for library functions and library variables declared in a static library header. A static library header file may include declarations of the library functions and library variables so that they can be referenced by code outside the static library. The library functions and library variables declared by the static library header file may be referred to as the library application programmable interface (API).

To use the static library, a developer may write code (referred to as “developer code”) that references the static library header and makes calls to the library functions or reads/writes to the library variables. In compiling the developer code and the static library, a compiler or a linker may resolve references in the developer code to the library functions or library variables to addresses in the static library.

### BRIEF DESCRIPTION OF THE DRAWINGS

FIG. 1 is a block diagram illustrating a system for performing dead code stripping on a static library, according to an example.

FIG. 2 is a flowchart illustrating a method for performing dead code stripping in a static library, according to an example.

FIG. 3 is a flowchart for a method for tracing the symbol dependencies found in the library objects of the static library that are added to the verified object list, according to an example.

FIG. 4 is a flowchart illustrating an example of an iteration of the dead code stripping loop that determines a symbol is not in a library object of the static library, according to an example.

FIG. 5 is a flowchart illustrating a method for dead code stripping using a platform specific library handler, according to an example.

FIG. 6 is a block diagram illustrating a computer device, in accordance with an example.

### DETAILED DESCRIPTION

Examples discussed herein may relate to removing dead code in a static library. A “static library,” as used herein, may refer to a linkable executable artifact. A static library may include a number of library objects that each provide executable definitions for programming functions (referred herein as “library functions”) and programming variables (referred herein as “library variables”). A library function or a library variable may be referenced according to a symbol. A static library header may declare symbols (referred to herein as “global symbols”) that can be referenced by external code linking in the static library.

Removal of dead code, accordingly, may refer to removing a library object from a static library based on a lack of a dependency relationship (direct or indirect) between a global symbol and the removed library object. A direct dependency may occur when the library object directly defines a global symbol declared in a static library header. An indirect dependency may occur when a global symbol is defined by a first library object which, in turn, references a symbol defined by a second library object. In this case, the global symbol indirectly depends on the second library object.

Removing dead code may be useful in some cases when a static library provider wishes to release or otherwise publish a static library as part of a software development kit (“SDK”). In some cases, the library objects of the static library may include functionality not utilized by the API defined in the static library header. Thus, removing dead code may result in a pruning out unnecessary library objects prior to releasing the SDK. As a result, the SDK after dead code pruning may be of comparatively smaller size. Additionally, the code that is removed from a static library through dead code stripping avoids being reverse engineering.

In one aspect, a symbol list may be created based on global symbols declared in a static library header. A symbol-to-object mapping may also be created from the static library. The symbol-to-object mapping may include data that maps the global symbols to library objects of the static library. An iteration of a dead code stripping loop may be executed. The first iteration may involve selecting a first global symbol from the global symbol list. The first iteration may also involve, using the symbol-to-object mapping, determining that the first symbol is defined by a first object. Still further, the first iteration may involve adding the first object to a verified object list. Library objects are then removed from the static library that are absent from the verified object list.

These and other examples are discussed in greater detail below.

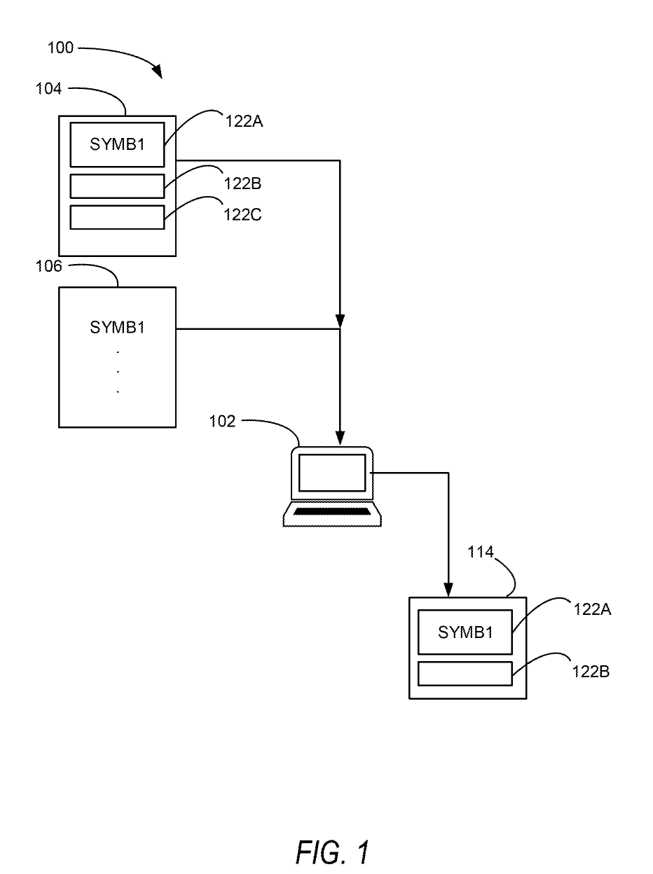

FIG. 1 is a block diagram illustrating a system 100 for performing dead code stripping on a static library, according to an example. FIG. 1 shows that the system 100 may include a code stripping module 102, a static library 104, a static library header 106, and a stripped static library 114. It is to be appreciated that other embodiments may include more or less components. For example, in some cases, a system may include multiple code stripping modules, static libraries, static library headers, and/or stripped static libraries.

The static library 104 may be a file that may be released as part of a SDK. As described above, a static library may refer to a linkable object that provides linkable executable code, such as functions (referred herein as “library functions”) and variables (referred herein as “library variables”). The static library may include multiple library objects, such as library objects 122A-C, where each library object is relocatable format machine code that contains the definitions for some of the library functions. FIG. 1 shows that the library object 122A includes the definition of a global symbol (e.g., SYMB1).

The static library header 106 may be a file that includes declarations for static library functions and static library variables, referred to herein as global symbols, that can be referenced by external code that links the static library 104. A developer creating a program may include (e.g., in C/C++, using #include preprocessor directives) the static library header 106 in developer code so that the developer code can call or otherwise accesses these global symbols. For example, the static library header 106 shown in FIG. 1 includes a declaration for SYMB1. Source code that includes the static library header 106 can then accordingly include code that references the global symbol SYMB1 without causing a compiler error. When the code is compiled into an executable, a compiler or linker may resolve the memory addresses the code uses to reference SYMB1 to a memory address associated with the definition of SYMB1 as may be located in library object 122A.

The stripping code module 102 may be a computer system that performs dead code stripping on a static library. In dead code stripping, the stripping code module 102 may trace through the symbol dependencies found by the library objects. If a library object is verified as having a symbol definition to which a global symbol depends on, then that library object may remain in the static library; otherwise, the stripping code module 102 may remove the library object from the static library.

The stripped static library 114 may be an output or artifact of the stripping code module 102. As FIG. 1 shows, the stripped static library 114 may include library objects 122A,B but not library object 122C. Such may be the case because library object 122A includes the definition for SYMB1, which is declared in the static library header 106. Further, in some cases, the library object 122A may access other symbols (e.g., functions or variables), some of which may be defined in other library objects. This situation illustrates one possible reason why library object 122B may also be included in the stripped static library 114.

Operations for performing dead code stripping are discussed in greater detail in the foregoing.

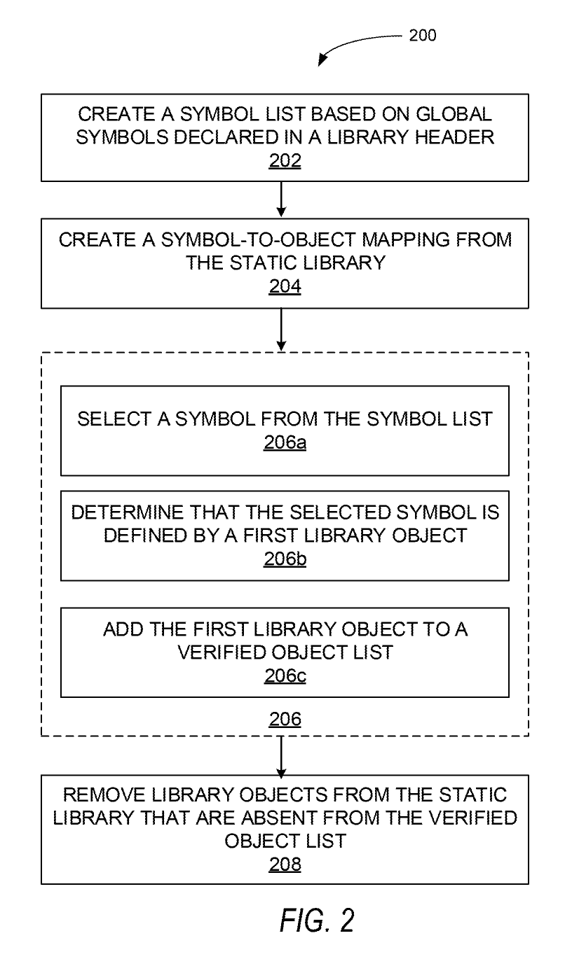

FIG. 2 is a flowchart illustrating a method 200 for performing dead code stripping in a static library, according to an example. The method 200 may be performed by the modules, components, systems shown in FIG. 1, and, accordingly, is described herein merely by way of reference thereto. For example, in some cases, the method 200 may be performed by a code stripping module. It will be appreciated that the method 200 may, however, be performed on any suitable hardware.

The method 200 may begin at operation to 202 when a code stripper module creates a symbol list based on global symbols declared in a static library header. For example, the static library header may be a file that includes declarations for functions and/or variables. In some cases, before a symbol is added to the symbol list, the code stripper module may mangle the names of the global symbols. Mangling (otherwise referred to as “name mangling” or “name decoration”) may refer to a technique that a compiler may use to ensure unique symbol names. Such may be the case for a C++ compiler that compiles two C++ functions with different signatures into C equivalents. Mangling is used here because a C convention may prohibits two functions from having the same symbol. Mangling may be platform and architecture specific.

At operation 204, the code stripper module may create a symbol-to-object mapping from the static library. The symbol-to-object mapping may be a data structure that specifies which symbols a library object defines. To create the symbol-to-object mapping, the code stripper module may extract data from metadata contained in the static library. Such metadata may be an index to symbol tables contained by the individual library objects. Further, the code stripper module may also create a symbol-to-object mapping that includes symbols that a given library object references but are defined outside of that given library object.

At operation 206, the code stripper module may execute a dead code stripping loop. The code stripping module can perform multiple iterations of the dead code stripping loop (e.g., until the symbol list is empty). In an example iteration of the dead code stripping loop, the code stripper module may, at operation 206a, select a symbol from the symbol list. In an initial iteration, the first symbol may be a global symbol defined by the static library header, such as “SYMB1” (as shown in FIG. 1). In some cases, the code stripper module may pop or otherwise remove a symbol from the symbol list when that symbol is selected.

Then, at operation 206b, using the symbol-to-object mapping, the code stripping module may determine that the selected symbol is defined by a first library object. With momentary reference to FIG. 1, the symbol-to-object mapping may map SYMB1 to library object 122A.

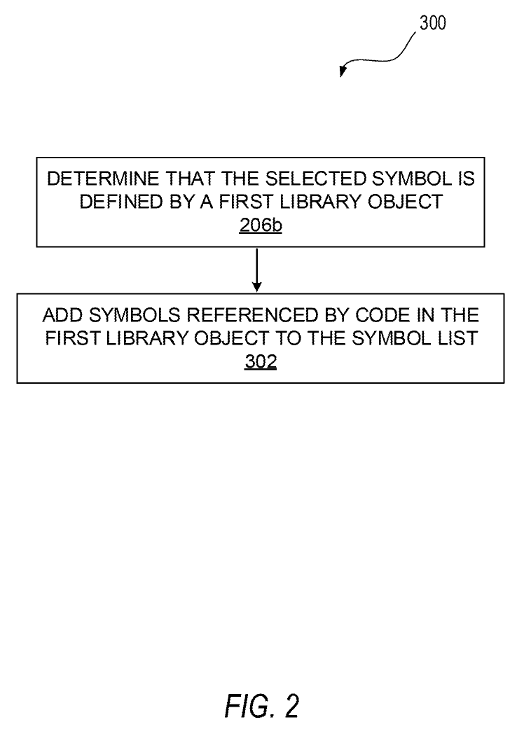

At operation 206c, the code stripping module adds the first library object to a verified object list. A verified object list may be data or logic that signifies that a library object is to remain in the static library after performing dead code stripping. Conversely, library objects that are missing from the verified object list are to be stripped or otherwise removed from the static library. Although not shown in FIG. 2, the code stripping module may trace through symbol dependencies of the library object added to the verified object list. This is discussed below with reference to FIG. 3.

After executing the dead code stripping loop, the code stripping module may, at operation 208, remove library objects from the static library that are absent from the verified object list.

As discussed above, the dead code stripping loop may trace through the symbol dependencies found in the library objects added to the verified object list. Such a dependency may exist, for example, where one library object makes a call to a function defined by another library object.

FIG. 3 is a flowchart for a method 300 for tracing the symbol dependencies found in the library objects of the static library that are added to the verified object list, according to an example. The method 300 may extend the method 200, and is shown in reference thereto. For example, after operation 206b, the code stripper module may, at operation 302, add symbols referenced by code in the first library object to the symbol list. By adding the symbols referenced locally by a library object in the verified object list, the code stripping module evaluates the referenced symbols in subsequent iterations of the dead code stripping loop. That is, the code stripping module may determine which of the library objects (if any) define the symbols referenced locally by the verified library object.

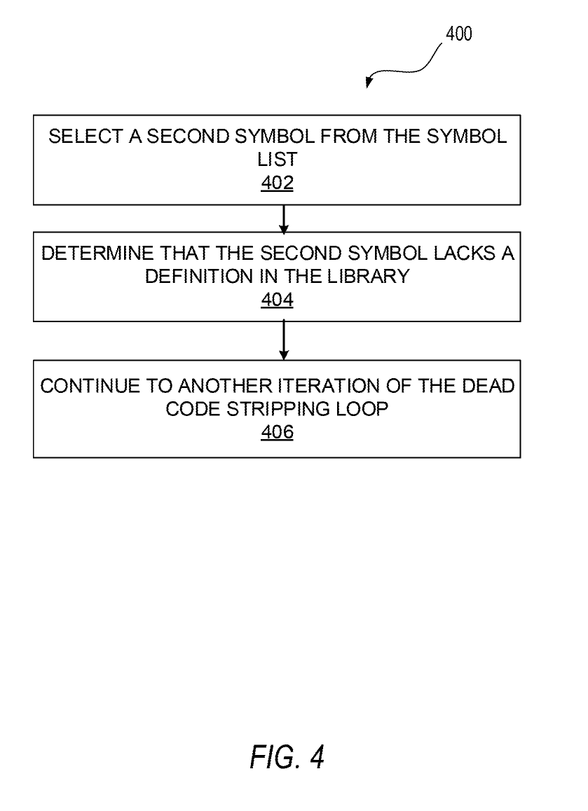

Some iterations of the dead code stripping loop may determine that a symbol in the symbol list is not defined by a library object or has already been verified. FIG. 4 is a flowchart illustrating an example of an iteration of the dead code stripping loop that determines a symbol is not defined by a library object of the static library, according to an example. For example, at operation 402, the code stripping module may select a second symbol from the symbol list.

Then, using the symbol-to-object mapping, the code stripping module may, at operation 404, determine that the second symbol lacks a definition in the library. By way of example and not limitation, this determination may occur when the symbol is to link to a library object outside of the static library (e.g., another static library) or defined by a library object that is already in the verified object list.

At operation 406, based on determining that the second symbol lacks the definition in the library, the code stripping module may continue to another iteration of the dead code stripping loop.

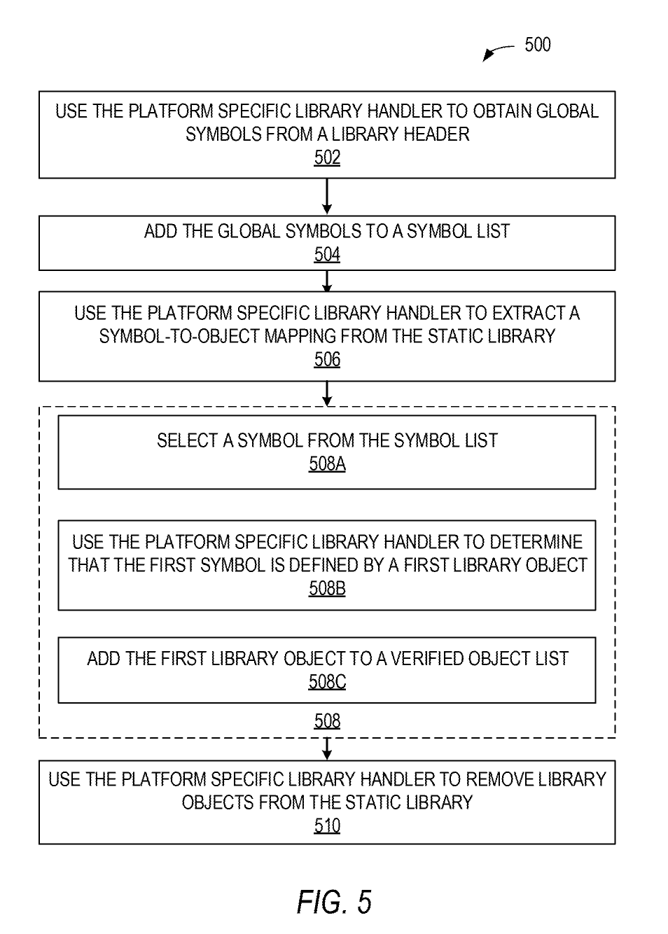

In some examples, the code stripping module may use a generic framework for stripping dead code from a static library. The generic framework may receive a platform specific library handler that performs operations that are specific to a given platform or configuration, such as symbol name mangling, symbol lookups, and the like. FIG. 5 is a flowchart illustrating a method 500 for dead code stripping using a platform specific library handler, according to an example.

At operation 502, the code stripping module may use the platform specific library handler to obtain global symbols from a static library header.

At operation 504, the code stripping module may add the global symbols to a symbol list. The code stripping module may perform operation 504 as part of the generic framework.

At operation 506, the code stripping module may use the platform specific library handler to extract a symbol-to-object mapping from the static library.

At operation 508, the code stripping module may execute a first iteration of a dead code stripping loop. The code stripping module may involve a number of sub-operations. For example, at sub-operation 508a, the code stripping module may select a first global symbol from the global symbol list. In some cases, selecting a global symbol from the global symbol list may remove or otherwise pop the symbol from the symbol list.

At operation 508b, using the symbol-to-object mapping, the code stripping module may use the platform specific library handler to determine that the first symbol is defined by a first library object.

At operation 508c, the code stripping module adds the first library object to a verified object list.

Although not shown, the code stripping module may perform additional iterations of the dead code stripping loop. For example, the code stripping module may execute iterations of the dead code stripping loop until the symbol list is empty.

After the codes stripping module finishes execution of the dead code stripping loop, the code stripping module may, at operation 510, use the platform specific library handler to remove library objects from the static library that are absent from the verified object list.

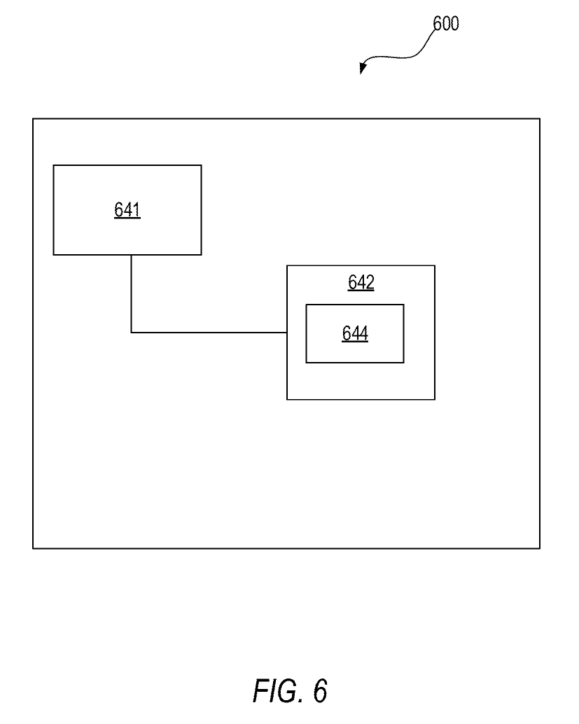

FIG. 6 is a block diagram illustrating a computer device 600, in accordance with an example. The computer device 600 may include a processor 641 and a computer-readable storage device 642. The processor 641 may be a device suitable to read and execute processor executable instructions, such as a CPU, or an integrated circuit configured to perform a configured function. The processor executable instructions may cause the processor 641 to implement techniques described herein.

The processor 641 shown in FIG. 6 is coupled to the computer-readable storage device 642. The computer-readable storage device 642 may contain thereon a set of instructions, which when executed by the processor 641, cause the processor 641 to execute the techniques described herein. For example, the computer-readable storage device 642 may include dead code stripping instructions 644.

For example, in one aspect, execution of the instructions 644, whole or in part, may cause the processor 641 to receive a static library and a static library header. The instructions then cause the processor 641 to obtain symbols specified by the static library header. The instructions then cause the processor to identify dependency relationships between the symbols specified by the static library header and library objects in the static library. The instructions also causing the processor to remove library objects from the static library that lack the dependency relationships with the symbols specified by the static library header.

What is claimed is:

1. A method comprising:
creating a symbol list based on global symbols declared in a static library header;
creating a symbol-to-object mapping from the static library, the symbol-to-object mapping including data that maps symbols to respective library objects of the static library;
executing a first iteration of a dead code stripping loop, the first iteration comprises:
selecting a first symbol from the symbol list,
using the symbol-to-object mapping, determining that the first symbol is defined by a first library object, and
adding the first library object to a verified object list; and
removing library objects from the static library that are absent from the verified object list.

2. The method of claim 1, further comprising mangling the global symbols declared in the static library header before creating the symbol list.

3. The method of claim 1, after determining that the first symbol is defined by the first library object, adding symbols referenced by the first library object to the symbol list.

4. The method of claim 3, wherein the symbols referenced by the first library object are selected in subsequent iterations of the dead code stripping loop.

5. The method of claim 1, further comprising executing additional iterations of the dead code stripping loop until the symbol list is empty.

6. The method of claim 1, further comprising executing a second iteration of the dead code stripping loop, the second iteration comprises:
selecting a second symbol from the symbol list;
using the symbol-to-object mapping, determining that the second symbol lacks a definition in the static library; and
based on determining that the second symbol lacks the definition in the static library, continuing to another iteration of the dead code stripping loop.

7. A machine-readable storage device comprising instructions that, when executed, cause the processor to:
receive an interface to a platform specific library handler;
using the platform specific library handler to obtain global symbols from a static library header;
add the global symbols to a symbol list;
using the platform specific library handler to extract a symbol-to-object mapping from the static library, the symbol-to-object mapping including data that maps symbols to respective library objects of the static library;
execute a first iteration of a dead code stripping loop, the first iteration, when executed, causes the processor to:
select a first symbol from the global symbol list,
using the symbol-to-object mapping, using the platform specific library handler to determine that the first symbol is defined by a first library object, and
add the first library object to a verified object list; and
using the platform specific library handler to remove library objects from the static library that are absent from the verified object list.

8. The machine-readable storage device of claim 7, wherein the platform specific library handler is specific to a given compiler.

9. The machine-readable storage device of claim 7, wherein the instructions cause the processor to remove the library objects from the static library by creating a copy of the static library, wherein the copy lacks the removed library objects.

10. The machine-readable storage device of claim 7, wherein the static library header is a file declaring an application programming interface (“API”) for the static library.

11. The machine-readable storage device of claim 7, wherein the global symbols declare at least one of a library function or a library variable.

12. A device comprising:
a processor; and
a machine-readable storage device comprising instructions that when executed, cause the processor to:
receive a static library and a static library header;
obtain symbols specified by the static library header;
identify dependency relationships between the symbols specified by the static library header and library objects in the static library; and
remove library objects from the static library that lack the dependency relationships with the symbols specified by the static library header.

13. The device of claim 12, wherein the instructions, when executed, cause the processor to publish the stripped static library as part of a software development kit (“SDK”).

14. The device of claim 12, wherein the symbols declare at least one of a library function or a library variable linkable by external code.

15. The device of claim 12, wherein the dependency relationships includes an indirect dependency relationship between a first symbol declared in the static library header and a first library object based on: a second library object defining the first symbol and the second library object referencing a symbol defined in the first library object.
